(19) United States
(12) Patent Application Publication
(10) Pub. No.: US 2009/0251421 A1
(43) Pub. Date: Oct. 8, 2009

(54) Method and apparatus for tactile perception of digital images

(75) Inventor: Leland Scott Bloebaum, Cary, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/099,318

(22) Filed: Apr. 8, 2008

(51) Int. Cl. G06F 3/041

(52) U.S. Cl. 345/173

(57) ABSTRACT

The method and apparatus enables a user to “feel” remote objects depicted in a visual scene. Exemplary embodiments of the invention detect image texture in a digital scene and generate tactile feedback control signals as a function of the detected image texture. In one exemplary embodiment, edge detection techniques are used to detect discontinuities in the digital scene, such as sharp changes in image luminous intensity. Tactile feedback is produced responsive to the tactile feedback control signals by a tactile feedback device. The tactile feedback may be in the form of a vibration and the tactile feedback device may be a vibrator. The strength of intensity of the vibration may be varied depending on the discontinuities in the digital scene.

### BACKGROUND

The present invention relates generally to the field of digital image processing and, more particularly, to a method and apparatus to enable tactile perception of visual images.

There is an increasing interest in various forms of virtual reality for business, entertainment, and educational purposes. In its purest form, virtual reality involves user interaction with a computer-simulated virtual environment. An early application of virtual reality was in various types of simulators, such as flight simulators. Today, the most common use of virtual reality is in connection with on-line video games, such as Linden Labs' Second Life, where the user interacts with a virtual world.

Recently, there has been interest in augmented reality, which combines computer-generated, virtual reality elements with real world experiences. An example of augmented reality is the yellow “first down” line seen in television broadcasts of football games, and the colored trail showing the motion of a puck in television broadcasts of hockey games. Current research in the field of augmented reality focuses primarily on the use of digital images which are processed and “augmented” by the addition of computer-generated graphics.

### SUMMARY

The present invention relates generally to a method and apparatus for augmenting visual perception of a digital image that enables a user to “feel” remote objects depicted in a visual image. Exemplary embodiments of the invention detect image texture in a digital image and generate tactile feedback control signals as a function of the detected image texture. A tactile feedback device, such as a vibrator, converts the tactile feedback control signals into tactile sensations. The vibrator may vary the intensity, frequency, and/or duty cycle of the vibration responsive to the tactile feedback control signals. In one exemplary embodiment, edge detection techniques are used to detect discontinuities in the digital image, such as sharp changes in image luminous intensity.

In one exemplary embodiment, tactile feedback is generated for the user of a video camera while the user captures a scene. As the user pans the scene with a video camera, the image captured by the video camera changes. The successive frames of the video may be processed in real time and detected changes from frame-to-frame may be used to generate tactile feedback for the user.

In another exemplary embodiment, a still image stored in memory is displayed to the user on a display. The user moves a cursor over the digital image to “feel” the objects depicted in the image. The cursor functions as a “digital finger.” As the digital finger moves over the image, discontinuities in the image where the digital finger traces a path are detected and used to generate tactile feedback for the user.

### BRIEF DESCRIPTION OF THE DRAWINGS

FIG. 1 illustrates a digital scene being displayed on a display.

FIG. 2 illustrates and exemplary augmented reality system for providing tactile sensation of visual images.

FIG. 3 illustrates an exemplary method for translating image texture in a digital scene 50 into tactile sensations.

FIG. 4 illustrates another digital scene being displayed on a display.

FIG. 5 illustrates a video camera with an augmented reality system according to one exemplary embodiment.

FIG. 6 illustrates a cellular phone with an augmented reality system according to one exemplary embodiment.

FIG. 7 illustrates a computer with an augmented reality system according to one exemplary embodiment.

### DETAILED DESCRIPTION

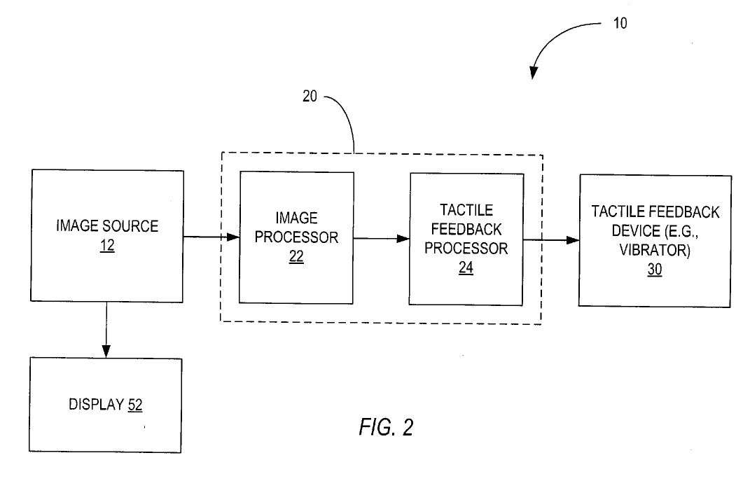

Referring now to the drawings, exemplary embodiments of an augmented reality system 10 to enhance visual perception of a recorded scene with a simulated sense of touch will be described. The augmented reality system 10, shown in FIG. 2, enables the user to “feel” remote objects captured in digital video or digital still image, collectively referred to herein as a digital scene. One or more digital images comprising a digital scene are processed to detect the “texture” in the digital scene. The image texture is translated into tactile feedback to provide the user with a sense of touch.

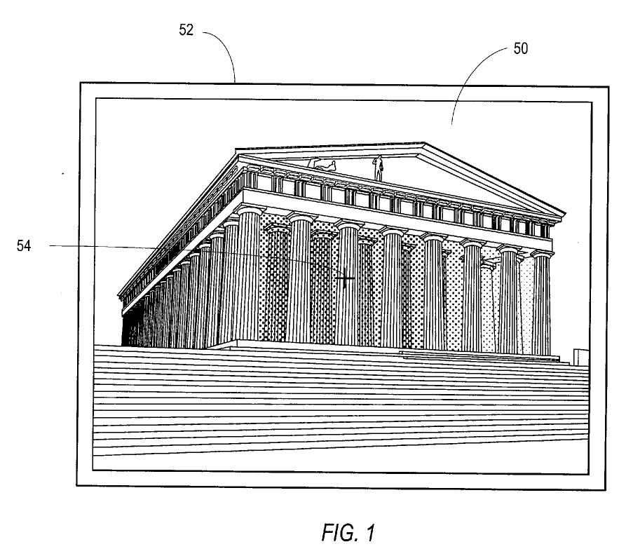

FIG. 1 provides a simple example to illustrate how the image texture in a digital scene 50 may be translated into tactile sensation by the augmented reality system 10. FIG. 1 illustrates an object of interest within a digital scene 50 that is being displayed to the user a display 52, such as a viewfinder in a video camera or a display of a computer. In this exemplary, the object of interest comprises a building with a colonnade, such as a Greek temple. A reference object 54, illustrated as a cross-hair in FIG. 1, appears on the display 52. Changes in depth in the real scene create edges in the digital scene 50 that may be detected as the reference object 54 moves over the object of interest captured in the digital scene 50. For example, when the user moves the reference object 54 across the colonnade in the digital scene 50, the augmented reality system 10 may detect the edges of the columns using edge detection techniques and generate vibrations when the reference object 54 crosses the edges of the columns. Thus, the user may feel bumps as the reference object 54 crosses over the columns.

FIG. 2 illustrates an exemplary augmented reality system 10. The main elements of the augmented reality system 10 comprise an image source 12 for generating or providing a digital scene 50, a touch simulator 20 for processing the digital scene 50 provided by the image source 12 and for generating a tactile feedback signal, and a tactile feedback device 30 responsive to the tactile feedback signal from the touch simulator 20 to generate tactile sensation, such as vibration, heat, etc. The image source 12 may comprise a video camera, still camera, scanner, or other image capture device. In some embodiments, the image source 12 may comprise a storage device comprising memory for storing digital video and/or still images. For example, the image storage device may comprise a mass storage device, such as solid-state memory, a magnetic disk, or an optical disk. In some devices, the memory may comprise a removable memory device, such as a memory card or flash disk.

The basic function of the touch simulator 20 is to translate digital images of remote objects in a digital scene 50 into tactile feedback control signals representing tactile sensation. The touch simulator 20 may comprises or more processors, hardware, or a combination thereof for processing digital scenes, identifying image textures within the digital scene, and generating tactile feedback control signals based on the detected image textures. In one exemplary embodiment, the touch simulator 20 comprises an image processor 22 and tactile feedback processor 24. The image processor 22 receives a digital scene 50 from the image source 12, analyzes the visual content of the digital scene 50, and outputs image texture information to the tactile feedback processor 24. For example, the image texture information may reflect the discontinuities in the digital scene 50, such as when an edge is encountered by the reference object 54. The tactile feedback processor 24 processes the image texture information from the image processor 22 to generate a tactile feedback control signal to control a tactile feedback device 30.

The tactile feedback device 30 may comprise any transducer that converts electrical signals into tactile sensations. For example, the tactile feedback device 30 may comprise one or more vibrators that convert electrical signals into vibrations that may be sensed by the user. The tactile feedback device 30 may be incorporated into an image capture device, such as a video camera, so that tactile feedback is provided to the user while the digital scene 50 is being captured. The tactile feedback device 30 may also be incorporated into a mouse or other pointing device that controls movement of the reference object 54 relative to the objects in the digital scene 50. In embodiments where the tactile feedback device 30 is incorporated in a device (e.g. a mouse) that is separate from other elements of the augmented reality system 10, the tactile feedback control signal may be sent to the tactile feedback device 30 via a wired or wireless link.

The tactile feedback control signals generated by the tactile feedback processor 24 may be used to control one or more properties of the tactile feedback device 30. In the case of a vibrator, for example, the tactile feedback control signals may be used to control the intensity, frequency, duration, or other properties of the vibration depending on the image texture. For example, when the reference object 54 crosses the edges of the columns shown in the digital scene 50 in FIG. 1, a high intensity, low frequency vibration may be generated to simulate bumps. As another example, when the reference object 54 moves over a textured surface in the digital scene 50, the frequency and intensity of the vibration may be adjusted to reflect the degree of roughness.

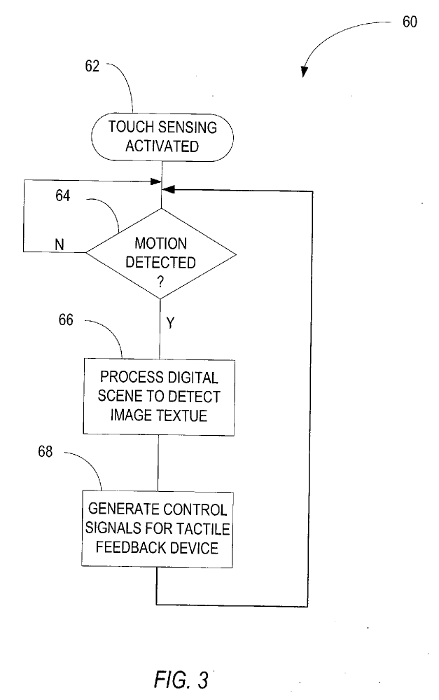

FIG. 3 illustrates an exemplary procedure 60 for generating tactile sensations based on the visual content of a digital scene 50 according to one exemplary embodiment. The procedure 60 begins when tactile sensing of the visual content of the image is activated (block 62). The image processor 22 detects movement of the reference object 54 relative to the digital scene 50 (block 64). In some embodiments, relative motion may occur when a video capture device is moved while a real scene is captured. The captured video may be stored in memory and/or viewed in the device's viewfinder. Relative motion may also occur when a previously captured and stored video is played back from memory. In other embodiments, relative motion may result from panning and zooming a previously captured and stored still image being displayed on display 52 of an image display device. If motion of the reference object 54 is detected, selected image data within the digital scene 50 is analyzed to detect image textures such as edges, lines, texture patterns, etc. (block 66). The image texture information extracted during the image processing step is then translated into tactile feedback control signals to control a tactile feedback device 30 (block 68). The nature of the tactile feedback control signals will necessarily depend on the type of the tactile feedback device 30 being used. For example, when the tactile feedback device 30 comprises a vibrator, the tactile feedback processor 24 may generate tactile feedback control signals to control the intensity, frequency, and duration of the vibration. In some embodiments of the invention, multiple tactile feedback devices 30 may be used and different tactile feedback control signals may be generated for each of the tactile feedback devices 30.

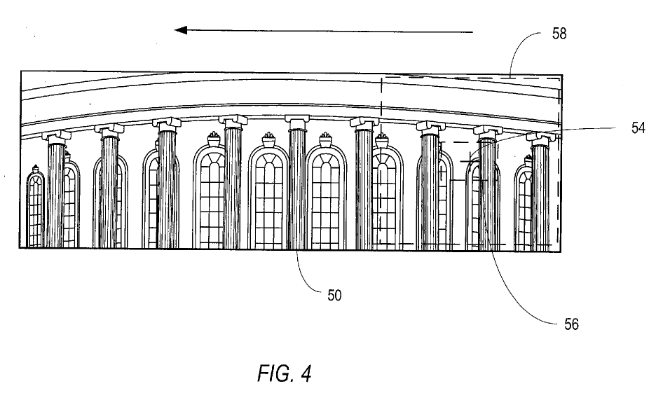

It will typically not be necessary to analyze the entire digital scene 50. Instead, the image processor 22 may restrict analysis of the digital scene 50 to a small area around the reference object 54. Thus, the reference object 54 functions somewhat like a virtual finger. FIG. 4 illustrates the reference object 54 as it is moved across the digital scene 50. The textures encountered by the reference object 54 are analyzed and translated into tactile sensations. In one exemplary embodiment, a sensing window 56 within a video frame 58 and surrounding the reference object 54 is defined. The sensing window 56 need not be visible to the user. The sensing window 56 moves with the reference object 54. As the reference object 54 moves, the image data within the sensing window 56 is analyzed to detect image textures encountered by the reference object 54. In some embodiments, it may be possible for the user to vary the size of the sensing window 56. Increasing the size of the sensing window 56 may increase the detection capabilities of the image processor 22 at the cost of more processing resources.

In one exemplary embodiment, the image processor 22 detects the visual texture of an image based on the spatial variations in pixel intensity and/or pixel color. The visual textures detected may comprise edges, lines, boundaries, texture patterns, etc. in the digital scene 50. The visual textures in the digital scene 50 result from the physical characteristics or properties of the objects captured in the digital scene 50. For example, changes in depth in a real scene may result in edges or lines that may be detected by the image processor 22. Similarly, surface features of objects captured in a digital scene 50 may produce texture patterns that may be detected.

The image processor 22 may apply known edge detection and/or texture analysis algorithms to analyze the image and output image texture information to the tactile feedback processor 24. Edge detection is a fundamental process used in image processing applications to obtain information about images as a first step in feature extraction and object segmentation. There are many known techniques for edge detection. The majority of edge detection techniques may be classified into two groups referred to as gradient methods and Laplacian Methods. The gradient methods detect edges by looking for the maximum and minimum in the first derivative (e.g., gradient) of the image. The Laplacian Methods search for zero crossings in the second derivative of the image to find edges. Exemplary edge detection techniques suitable for the present invention include Sobel edge detection, Canny edge detection, and differential edge detection.

In some embodiments of the invention, image processor 22 may also perform texture analysis to detect the surface properties of objects captured in the digital scene 50. For example, a picture of a stone wall or brick wall will produce a near regular texture pattern that may be detected through texture analysis. Also, surface properties of the depicted objects, such as the degree of roughness and coloration, may result in texture patterns in the visual image. The texture patterns may be structured or stochastic. Texture analysis may be used to identify regions of an image where the texture pattern is homogenous. The regions of an image having a homogenous texture pattern may be classified and tactile feedback may be generated based on the classification of texture patterns. For example, the textures may be classified based on varying degrees of roughness. When tactile feedback is in the form of vibration, one or more of the frequency, intensity, and duty cycle of the vibration may be varied, depending upon the roughness of the textures in an image.

In some embodiments, It may be advantageous to preprocess an entire digital scene embodied in a previously captured and stored image to create an image map to facilitate generation of tactile feedback control signals. The image map includes the edges and other textural features of the image. Thus, when the user pans or zooms the image, the current location of the reference object 54 may be compared with the predetermined location of edges and other textural features of the image map. The preprocessing may be performed when the image is opened for viewing and the image map created can be stored either temporarily or permanently in memory. In the later case, the image map may be stored as metadata with the image, or otherwise associated with the image.

The augmented reality system 10 may be incorporated into an image capture device or image display device. For example, the augmented reality system 10 may be incorporated into a video camera or still camera, a cellular phone with video capability, or a computer.

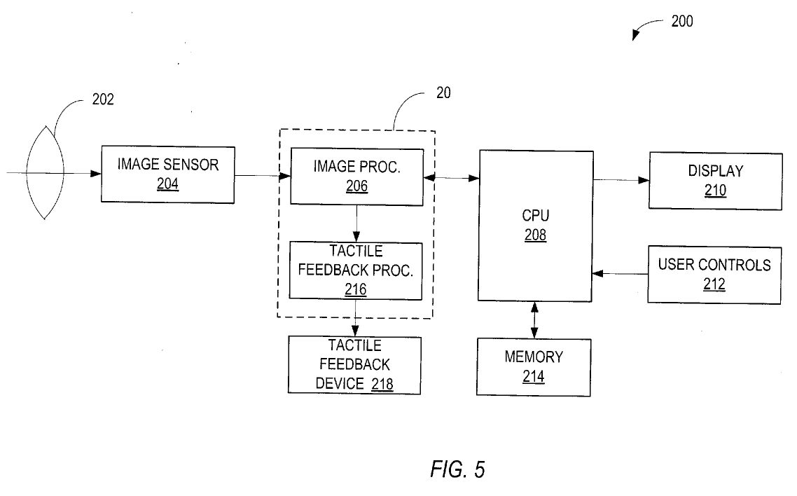

FIG. 5 shows a block diagram of a video camera 200 with an integrated augmented reality system 10. The main components of the video camera 200 comprise a lens assembly 202, an image sensor 204, an image processor 206, a central processing unit 208, a display 210, one or more user controls 212, and memory 214. Lens assembly 202 may comprise a single lens or a plurality of lenses that collect and focus light onto image sensor 204. Image sensor 204 captures images formed by the light. Image sensor 204 may be, for example, a charge-coupled device (CCD), a complementary metal oxide semiconductor (CMOS) image sensor, or any other image sensor known in the art. Image processor 206 processes raw image data captured by image sensor 204 for subsequent storage in memory 214 or output to the display 210. Display 210 may comprise, for example, a liquid crystal display that functions as a viewfinder and allows the user to see the image being captured. User controls 212 comprise buttons, dials, switches, and other input controls that provide the user with the ability to control the video camera 200. Memory 214 stores programs and data needed by the central processing unit 208 for operation. In addition, memory 214 stores digital video and images captured by the video camera 200. Central processing unit 208 interfaces with the image processor 206, display 210, user controls 212, and memory 214 and controls the overall operation of the video camera 200.

The video camera 200 further comprises a tactile feedback processor 216 and a tactile feedback device 218 to generate tactile sensations responsive to the image texture of the digital scene 50 captured by the video camera 200. The image processor 206 and tactile feedback processor 216 function as the touch simulator 20 shown in FIG. 2. The tactile feedback processor 216 generates tactile feedback control signals that are output to the tactile feedback device 218 based on image texture information from the image processor 206 as previously described. The tactile feedback device 218 may, for example, comprise a vibrator to generate tactile sensation based on tactile feedback control signals from the tactile feedback processor 216 as previously described.

The video camera 200 is used in a conventional manner to capture video of a real scene. The captured video is stored in memory 214 and may be output to the display 210 in real time while the video is being recorded. The reference object 54 may be shown in the display 210 as previously described. As the user moves the camera 200 to record a digital scene 50, the reference object 54 will move within the recorded scene 50. The captured video is processed in real time and tactile feedback is generated to provide the user with a sense of touch. Those skilled in the art will appreciate that the tactile feedback can be generated even when image recording is turned off and the scene is being viewed but not recorded.

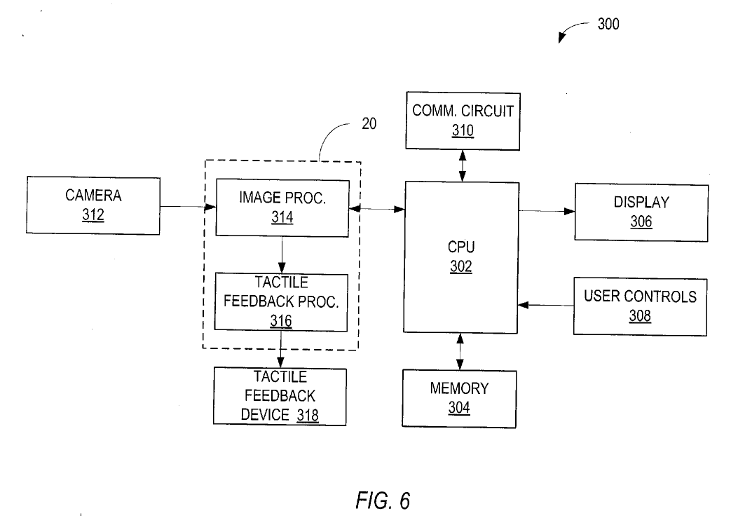

FIG. 6 illustrates another exemplary embodiment of the invention incorporated into cellular phone 300. The main elements of the cellular phone 300 comprise a central processing unit 302, memory 304, display 306, one or more user controls 308, and a communications circuit 310. The central processing unit 302 controls overall operation of the cellular phone 300. Programs and data needed for operation are stored in memory 304. Display 306 and user controls 308 enable user interaction with the cellular phone 300. Display 306 may comprise a liquid crystal display that outputs information for viewing by the user. User controls 308 may comprise keypads, buttons, jog dials, navigation controls, touch pads, or other known input devices that receive user input. In some embodiments, the display 306 may comprise a touch screen display that also functions as a user control 308. The communications circuit 310 may comprise a conventional cellular transceiver operating according to known standards, such as GSM and WCDMA, or according to standards that may be adopted in the future. Also, the communications interface could comprise a wireless LAN interface, such as a WiFI or WiMax interface.

The cellular phone 300 may store digital images including digital video in memory 304, which the user may view on the display 306. Additionally, the cellular phone 300 may include an integrated video camera 312. The images captured by the camera 312 may be stored in memory 304 for subsequent viewing or output to the display 306 in real time while the video is being captured.

The cellular phone 300 may include an image processor 314, tactile feedback processor 316 and tactile feedback device 318. The image processor 314 may perform conventional image processing functions, such as compression and decompression. Additionally, the image processor 314, along with the tactile feedback processor 316, function as the touch simulator 20 shown in FIG. 2. The tactile feedback processor 316 generates tactile feedback control signals that are output to the tactile feedback device 318 based on image texture information from the image processor 314 as previously described. The tactile feedback device 318 may, for example, comprise a vibrator to generate tactile sensation based on tactile feedback control signals from the tactile feedback processor 316 as previously described. The vibrator for generating tactile feedback may be the same or different from the one that is used for notification functions.

The cellular phone 300 may be used as a video camera as previously described. In this case, tactile feedback may be generated in real time while a scene 50 is being captured and displayed on the viewfinder and/or stored in memory. Also, digital scenes 50 stored in memory 304 may be retrieved from memory 304 and displayed for viewing on display 306. The reference object 54 as shown in FIG. 1 may also appear on the display 306 when touch sensing is activated. In the case of a still image, the user may use the user controls 308 to pan and zoom the image on the display 306. As the user pans and zooms, the reference object 54 moves within the digital scene 50 and tactile feedback may be generated.

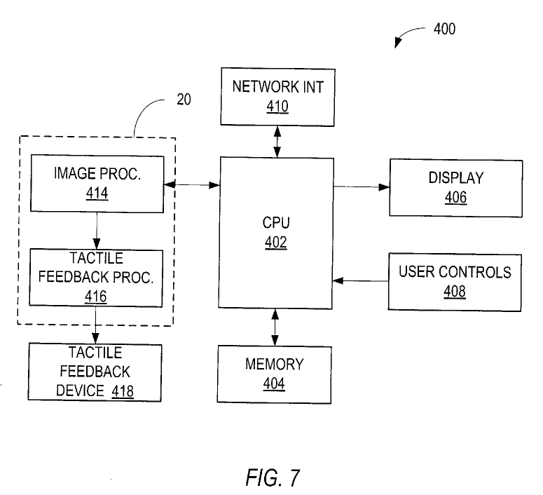

FIG. 7 illustrates another exemplary embodiment of the invention incorporated into a computer 400. The computer 400 comprises a central processing unit 402, memory 404, display 406, one or more user controls 408, and a network interface 410. The central processing unit 402 controls overall operation of the computer 400. Programs and data needed for operation are stored in memory 404. Display 406 and user controls 408 enable user interaction with the computer 400. Display 406 may comprise a CRT monitor or liquid crystal display that outputs information for viewing by the user. User controls 408 may comprise keyboards, pointing devices (e.g. mouse), touch pads, game controllers, or other known input devices that receive user input. In some embodiments, the display 406 may comprise a touch screen display that also functions as a user control 408. The network interface 310 may comprise a conventional Ethernet interface, serial interface, or wireless LAN interface, such as a WiFI or WiMax interface.

The computer 400 further includes an image processor 414, tactile feedback processor 416 and tactile feedback device 418 that may be connected with computer 400 either by wire or wirelessly. The image processor 414 may perform conventional image processing functions, such as compression and decompression. Additionally, the image processor 414, along with the tactile feedback processor 416, function as the touch simulator 20 shown in FIG. 2. The tactile feedback processor 416 generates tactile feedback control signals that are output to the tactile feedback device 418 based on image texture information from the image processor 414 as previously described. The tactile feedback device 418 may, for example, comprise a vibrator to generate tactile sensation based on tactile feedback control signals from the tactile feedback processor 416 as previously described. The tactile feedback device 418 may, for example, be incorporated into the mouse device or other user input device 408.

The computer 400 may store digital images including digital video in memory 404, which the user may view of the display 406 for viewing. The displayed image may be a video image or still images. During viewing, a reference object 54 may be displayed for the user on the display 406 overlying the image. The user may pan and zoom the image using standard user controls 408, such as a mouse, trackball, jog dial, navigation keys, etc. The reference object 54 may remain fixed in the center of the display 406. As the user navigates (i.e., pans and zooms) the image, the position of the reference object 54 relative to the image changes. In other embodiments, the user may use the user controls 408 to move the reference object 54 over the image. In either case, the relative position of the reference object 54 with respect to the image changes. The touch simulator 20 analyzes the visual content of the image as the relative position of the reference object changes and provides tactile feedback to the user. In this case, the tactile feedback device 418 may be contained in a mouse, keyboard, or other input control.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of generating tactile feedback to augment visual perception of a digital scene, said method comprising:
detecting image texture in a digital scene; and
generating tactile feedback control signals as a function of the detected image texture.

2. The method of claim 1 wherein detecting image texture in said digital scene comprises detecting image texture in a digital video of a scene captured while the user pans an image capture device.

3. The method of claim 1 wherein detecting image texture in said digital scene comprises detecting image texture in a digital still image of a scene as the user navigates the still image.

4. The method of claim 1 wherein detecting image texture in said digital scene comprises detecting spatial variations in pixel intensity and/or pixel color in a predetermined sensing window of the digital scene.

5. The method of claim 4 wherein detecting image texture in a digital scene comprises detecting edges and boundaries in the digital scene based on said spatial variations in pixel intensity and/or pixel color.

6. The method of claim 4 wherein detecting image texture in a digital scene comprises detecting texture patterns in said digital scene based on said spatial variations in pixel intensity and/or pixel color.

7. The method of claim 1 wherein generating tactile feedback control signals comprises generating tactile feedback control signals as a reference object is moved relative to the digital scene.

8. The method of claim 1 further comprising generating tactile feedback responsive to said tactile feedback control signals.

9. The method of claim 1 wherein generating tactile feedback comprises producing vibration responsive to said tactile feedback control signals.

10. The method of claim 9 wherein generating tactile feedback comprises varying the properties of the vibration responsive to said tactile feedback control signals.

11. An augmented reality system for augmenting visual perception with tactile sensation, said device comprising:
an image processor to detect image texture in a digital scene; and
a tactile feedback processor to generate tactile feedback control signals as a function of the detected image texture.

12. The augmented reality system of claim 11 wherein the image processor is configured to detect image texture in said digital scene by detecting image texture in a digital video of a scene captured while the user pans an image capture device.

13. The augmented reality system of claim 11 wherein the image processor is configured to detect image texture in said digital scene by detecting image texture in a digital still image of a scene as the user navigates the still image.

14. The augmented reality system of claim 11 wherein the image processor is configured to detect image texture in said digital scene by detecting spatial variations in pixel intensity and/or pixel color in a predetermined sensing window of the digital scene.

15. The augmented reality system of claim 14 wherein the image processor is configured to detect image texture in a digital scene by detecting edges and boundaries in the digital scene based on said spatial variations in pixel intensity and/or pixel color.

16. The augmented reality system of claim 14 wherein the image processor is configured to detect image texture in a digital scene by detecting texture patterns in said digital scene based on said spatial variations in pixel intensity and/or pixel color.

17. The augmented reality system of claim 11 wherein the tactile feedback processor is configured to generate tactile feedback control signals as a reference object is moved relative to the digital scene.

18. The augmented reality system of claim 11 further comprising a tactile feedback device for producing tactile sensation responsive to said tactile feedback control signals.

19. The augmented reality system of claim 18 wherein said tactile feedback device comprises a vibrator.

20. The augmented reality device of claim 19 wherein the tactile feedback processor is configured to generate tactile feedback control signals for varying the properties of the vibration depending on the detected image texture.
